(19) United States
(12) Patent Application Publication
(10) Pub. No.: US 2022/0092210 A1
(43) Pub. Date: Mar. 24, 2022

(54) POLICY-BASED DATA MIGRATION

(71) Applicant: International Business Machines Corporation, Armonk, NY (US)

(72) Inventors: Emma Rose Tucker, Austin, TX (US); Amod Mukund Upadhye, Austin, TX (US); Jennifer Elizabeth Oliver, Austin, TX (US); Erick C. Espinoza, Austin, TX (US); Jason Mathew, Austin, TX (US)

(21) Appl. No.: 17/024,850

(22) Filed: Sep. 18, 2020

(51) Int. Cl. G06F 21/62; G06N 20/00; G06N 5/04; H04L 29/06

(52) U.S. Cl. CPC G06F 21/6245; H04L 63/0209; G06N 5/04; G06N 20/00

(57) ABSTRACT

Using a data catalog to determine whether or not to migrate data on a potentially enterprise-level scale (such as large-scale Cloud-based data) from a source location to a target location based on classification of the substantive data and automated policies.

### BACKGROUND

The present invention relates generally to the field of data usage, and more particularly to the migration of data.

The concept of data migration is known. The Wikipedia entry for “data migration” (as of Mar. 18, 2020) states as follows: “Data migration is the process of selecting, preparing, extracting, and transforming data and permanently transferring it from one computer storage system to another. Additionally, the validation of migrated data for completeness and the decommissioning of legacy data storage are considered part of the entire data migration process. Data migration is a key consideration for any system implementation, upgrade, or consolidation, and it is typically performed in such a way as to be as automated as possible, freeing up human resources from tedious tasks. Data migration occurs for a variety of reasons, including server or storage equipment replacements, maintenance or upgrades, application migration, website consolidation, disaster recovery, and data center relocation.”

### SUMMARY

According to an aspect of the present invention, there is a method, computer program product and/or system that performs the following operations (not necessarily in the following order): (i) receiving a data catalog, with the data catalog including a first plurality of metadata corresponding to a first entity's data; (ii) classifying, using a machine learning module, a first subset of the first plurality of metadata based, at least in part, upon a data catalog policy to obtain a first classified metadata set; (iii) determining that the first entity's data corresponding to the first classified metadata set must be migrated from a source location to a target location based, at least in part, upon the data catalog policy; and (iv) migrating the first entity's data corresponding to the first classified metadata set from the source location to the target location.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a flowchart showing a second embodiment method performed, at least in part, by a second embodiment system;

FIG. 5 is a flowchart showing a third embodiment performed, at least in part, by a third embodiment system;

FIG. 6A is a first block diagram of the third embodiment of a system according to the present invention; and

FIG. 6B is a second block diagram of the third embodiment of a system according to the present invention.

### DETAILED DESCRIPTION

Some embodiments of the present invention are directed towards using a data catalog to determine whether or not to migrate data on a potentially enterprise-level scale (such as large-scale Cloud-based data) from a source location to a target location based on classification of the substantive data and automated policies.

This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

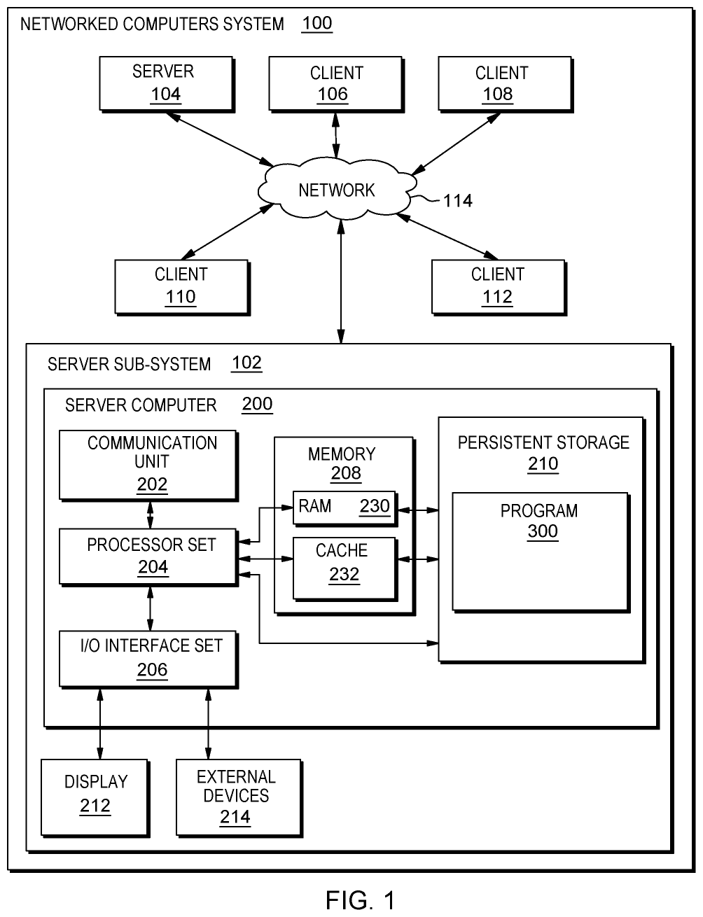

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

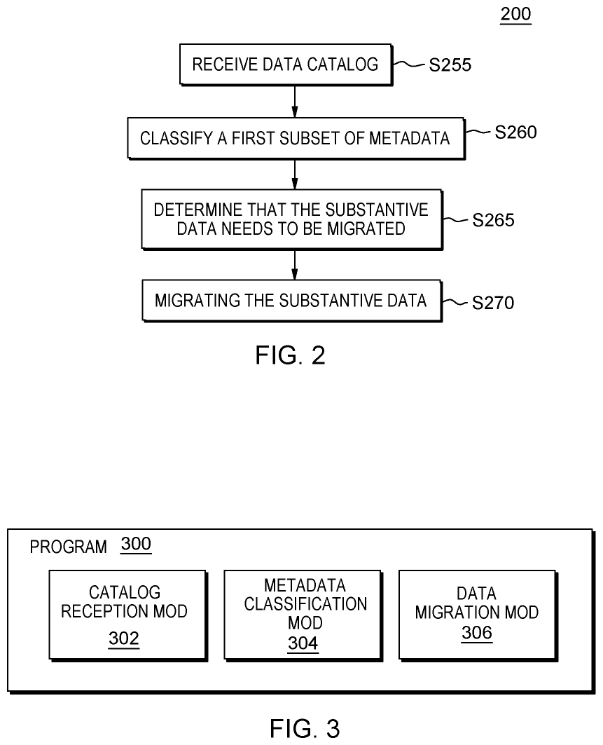

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where catalog reception module (“mod”) 302 receives a dataset that is contained in a first data catalog. In some embodiments, the dataset can be found in a source location such as DB2 (see below in connection with the operations from flowchart 400). In other embodiments, the dataset can be found in databases such as MongoDB, MySQL and/or Cloud Object Storage.

Processing proceeds to operation S260, where metadata classification mod 304 classifies a first subset of metadata corresponding to the first entity's underlying, substantive data based on a first data catalog policy. In some embodiments, metadata can be automatically added with a classification system that is based on information taken from a profile of each column of the substantive data. Alternatively, the metadata can be manually added (for example, by a data steward).

Processing proceeds to operation S265, where data migration mod 306 determines that the underlying, substantive data of the first entity (that the results of the classification to which operations S260 corresponds) needs to be migrated based upon the first data catalog policy. In some embodiments, the first data catalog policy includes rules and/or conditions to determine the type the underlying, substantive data. For example, one rule and/or condition can be that the substantive data must only be migrated if that substantive data is private and sensitive health related data of a given user (or set of users). In this case, if the results of the classification from operation S260 show that the metadata corresponds to private and sensitive health related substantive data, then that data must be migrated from a source location to a target location.

Alternatively, another rule and/or condition can be that the substantive data can only be migrated if that substantive data is non-private and non-confidential data. In this case, if the results of the classification from operation S260 show that the metadata corresponds to non-private and non-confidential data, then that data can be migrated from a source location to a target location.

In both of these given examples, the target location for the data migration is based on a pre-defined policy (that is, the determination of the target location is based on the first data catalog policy). For the purposes of this discussion, the first data catalog policy dictates more than just the rules and/or conditions governing whether the substantive data can or cannot be migrated, but also where that data can be migrated.

Finally, processing proceeds to operation S270 where data migration mod 306 migrates the underlying, substantive data of the first entity based on the first data catalog policy. However, if the determination is made in operation S265 that the underlying, substantive data must not be migrated based on the data catalog policy (for example, the substantive data might be publicly available information rather than personal identifiable information), then processing would not proceed to operation S270 and the substantive data would not be migrated from its current database.

### III. FURTHER COMMENTS AND/OR EMBODIMENTS

Some embodiments of the present invention recognize the following facts, potential problems and/or potential areas for improvement with respect to the current state of the art: (i) cloud computing is a significant disruptor in technology right now; (ii) as organizations choose to take advantage of the low cost and high performance capabilities with cloud computing-based products and/or services, they need to make a plan of action for migrating their current infrastructure over from their current storage systems to cloud-based storage system; (iii) typically, mass migration of data is difficult and can sometimes take years of effort to even make a dent; (iv) part of the data migration plan includes the migration of entire databases to a cloud-based storage database; and/or (v) in some instances, certain organizations will still need to keep a subset of their data on premise (that is, their current data storage systems) for compliance-related reasons.

Some embodiments of the present invention recognize the following facts, potential problems and/or potential areas for improvement with respect to the current state of the art: (i) it is hard to know exactly what data is located in what specific location; (ii) when migrating to cloud-based systems, organizations will need to know exactly what data they store and where, (typically by using a data catalog); (iii) the latest trend in data catalogs is to use machine learning programs to connect to multiple separate data sources and automatically classify information assets, which effectively reduces the manual work required for a data steward to classify every column of every information asset; (iv) the data catalog automatically describes columns in a data asset with technical metadata or data classes; (v) typically, those data classes are defined by java code, reference data, data fingerprint, etc.; (vi) this, in turn, attaches a classification to the data asset based on whether the data asset has columns that are automatically classified to have sensitive information or not; (vii) for example, the data catalog might have a data class for social security numbers; (viii) the data catalog knows when a column has a social security number because of java code expressing the format (that is, the syntax used to express a social security number is in a form and format that is readable by the software that analyzes the data catalog); and/or (ix) if an information asset is added to the data catalog that has social security numbers, that column will be associated with the social security number data class and the entire asset will be classified as having sensitive information.

Some embodiments of the present invention recognize the following facts, potential problems and/or potential areas for improvement with respect to the current state of the art: (i) typically, a data catalog user might set up a rule based on classification of an information asset; and/or (ii) for example, columns with social security numbers might be masked in order to preserve the privacy of the individual whose identity is linked to a given social security number.

Some embodiments of the present invention may include one, or more, of the following features, characteristics and/or advantages: (i) one issue addressed in this document is anchored upon the fact that a given user does not know certain unknown, and currently unascertained information; (ii) the use of a data catalog exists to help an organization find all of its data and ascertain the previously unascertained data; and/or (iii) when discussing specifically about cloud-based data migration, users do not always know the content of all of their data they need to keep on-premise and the content of the data that can move to a public cloud-based data storage system (such as confidential information including social security numbers of a given set of users, as mentioned above).

Some embodiments of the present invention create rules to help with migrating data assets to cloud-based storage systems or from cloud-based storage systems to on-premise data storage systems based on classification. For example, if an organization wants to move as much non-sensitive data to a public cloud-based storage system as possible, it can create a policy (that is, a set of conditions) that says the following: “If a data asset comes from an on-premise source and classification is not Personal Identifying Information, then migrate that data asset to a cloud-based storage system.”

In this example, the solution is to perform at least the following operations (not necessarily in the following order): (i) use a machine learning data catalog to find data (that may potentially be migrated from its origin source to a cloud-based storage system); (ii) automatically classify data based on rules and policies; and/or (iii) move data to an appropriate location, which can include a public cloud-based storage system or behind a firewall based on the policy set by a given organization).

In one embodiment of the present invention, there is a method for migrating data based on a classification system through the use of a data catalog. This method includes at least the following operations (not necessarily in the following order): (i) building a machine learning data catalog (sometimes referred to herein as a “data bank”) of a given entity's data, with the given entity's data coming from multiple data sources; (ii) classifying subsets of the given entity's data using a data catalog (that is based, at least in part, on pre-defined rules and/or policies); and/or (iii) automatically migrating at least a chosen sub-set of the given entity's data from a first location to a desired location based, at least in part, upon the respective classification of the selected sub-set of the given entity's data. In some embodiments of the present invention, a desired location for automatically migrating this sub-set of data includes, but is not necessarily limited to, a logical location on a public cloud-based server that is secured behind a firewall.

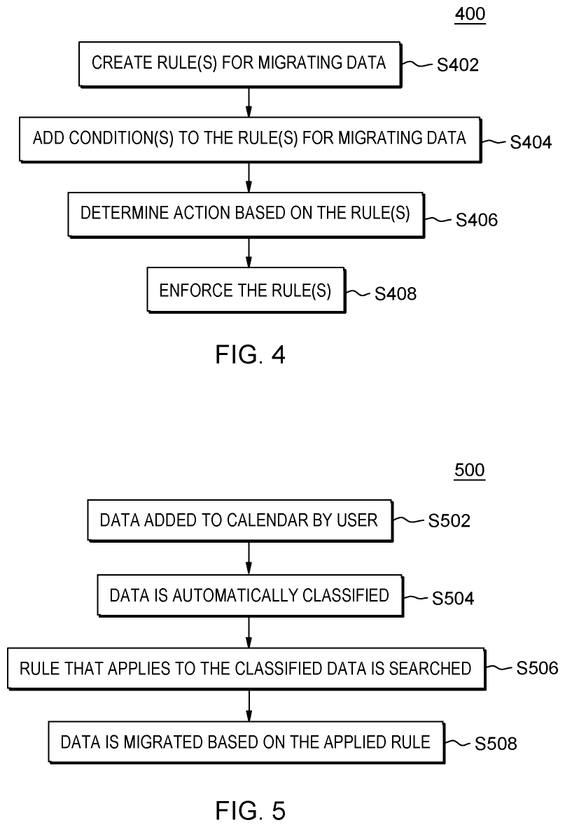

Discussion now will proceed to flowchart 400 of FIG. 4. The operational process illustrated by flowchart 400 provides a method for setting up a storage system from a user perspective. That is, the method will illustrate the creation of policies that certain embodiments of the present invention can use to determine whether migrating some (or all) of a given data set from a first location to a second location is appropriate.

Processing begins at operation S402, where a data governance officer (or a system administrator in some cases) will create a rule (or set of machine-logic based rules and/or conditions that will determine whether at least certain portions of data can be migrated) for their data catalog product.

Processing proceeds to operation S404 where the data governance officer will choose conditions for running the rule. For example, the set of conditions for running the rule set in operation S402 can be: “If classification does not equal ‘sensitive’ AND source of data is Database 2 (DB2).” In this example, if the rule determines that certain data is sensitive, then the data cannot be migrated (or alternatively, the sensitive data cannot be migrated).

In some embodiments of the present invention, the data governance officer can additionally select from the following conditions to run the rule set in operation S402: (i) If the substantive contains personal identifiable information (PII) and the source of the PII data is not MySQL, then migrate the PII data to MySQL, and (ii) If the data is tagged as “cloud ready” then migrate the data to MongoDB.

Processing proceeds to operation S406, where the data governance officer chooses actions for the rule created in operation S402. For example, the chosen action can be: “Move the data asset from DB2 to DB2 on Cloud.” Processing finally proceeds to and terminates at operation S408, where the data governance officer will enable the created rule so that the rule will run on: (i) all data assets that are published in the data catalog, and (ii) all future data assets that will be published on the data catalog.

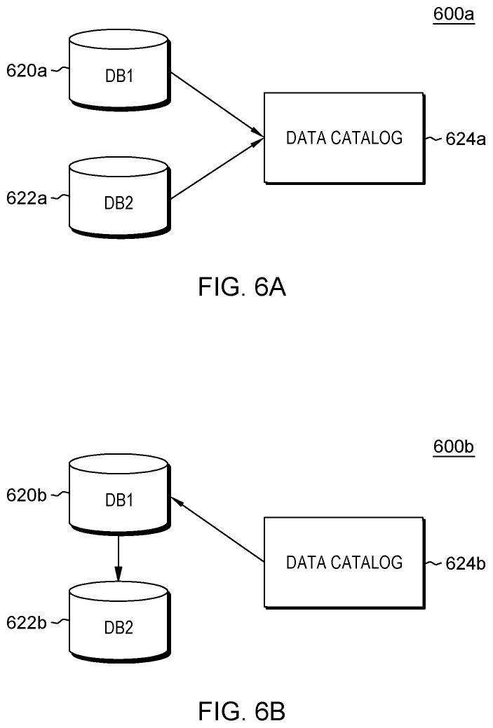

Discussion will now proceed to flowchart 500 of FIG. 5 and data migration block diagram 600a of FIG. 6A. Flowchart 500 and diagram 600a will be discussed in tandem (where appropriate), and will illustrate how data is migrated from an origin source to a secondary source from a system perspective, rather than from a user perspective.

Processing begins at operation S502, where a data steward publishes a data asset to its data catalog. When a given data asset is published to a data catalog (such as data catalog 624a), the database(s) (such as DB1 620a and/or DB2 622a) shares its metadata with the data catalog in addition to the underlying substantive data. This enables the data catalog to include a data table. Although the underlying substantive data is shared with the data catalog, the only data that is stored by the data catalog is the metadata.

Processing proceeds to operation S504 where the data catalog uses machine learning to profile the data (that is to be migrated) and assign data classes and classifications to the data when a data asset is published to the data catalog. This assignment of data classes and classifications is technically metadata because it uses java code, a regex expression, or another technical method to determine what data is in each column of the data asset. In some embodiments of the present invention, a data asset can be classified as “classification equals sensitive.” If there is no classification that exists to match that data asset, the data asset shows that “classification equals blank”.

Processing proceeds to operation S506 where the data catalog (such as data catalog 624a) will check to see whether a rule exists where its conditions match the metadata on the data asset. If a rule does exist with conditions that match the metadata on the data asset, the system will move to the next operation.

Processing proceeds to operation S508 where the data catalog will migrate the data asset based on the action prescribed in the rule. The data catalog will communicate with the on-premise database and the data asset will be moved to a target database. For example, the system could move a data asset marked as “classification equals blank” (that is, in the case where there is no classification that exists to match the data asset) from “DB2” to “DB2 on Cloud.” This operation is illustrated by data migration block diagram 600b of FIG. 6B, where: (i) DB1 (620b) represents the on-premise database, (ii) DB2 (622b) represents the target database, and (iii) Data Catalog 624b communicates with the on-premise database before the data asset is moved to the target database DB2 (622b).

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Policy and/or policy-based: A set of rules and/or conditions that trigger a desired action to be taken. In this document, the “desired action to be taken” generally refers to the migration of data (whether that data is an individual unit of data, a collection of units of data that constitutes a large-scale data migration, and/or any other collection of data units). The set of rules and/or conditions for determining the “desired action to be taken” can also be based on metadata.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a data catalog, with the data catalog including a first plurality of metadata corresponding to a first entity's data;
classifying, using a machine learning module, a first subset of the first plurality of metadata based, at least in part, upon a data catalog policy to obtain a first classified metadata set;
determining that the first entity's data corresponding to the first classified metadata set must be migrated from a source location to a target location based, at least in part, upon the data catalog policy; and
migrating the first entity's data corresponding to the first classified metadata set from a source location to a target location.

2. The CIM of claim 1 wherein the first entity's data corresponding to the first classified metadata set is personal identifiable information (PII).

3. The CIM of claim 1 wherein the classification of the first subset of the first plurality of metadata is done automatically based upon the data catalog policy.

4. The CIM of claim 1 wherein the target location for migrating the first entity's data corresponding to the first classified metadata set is behind a firewall.

5. The CIM of claim 1 wherein the target location for migrating the first entity's data corresponding to the first classified metadata set is to a public cloud-based server.

6. The CIM of claim 1 wherein the data catalog policy is created by a data governance officer.

7. A computer program product (CPP) comprising:
a machine readable storage device; and
computer code stored on the machine readable storage device, with the computer code including instructions and data for causing a processor(s) set to perform operations including the following:
receiving a data catalog, with the data catalog including a first plurality of metadata corresponding to a first entity's data,
classifying, using a machine learning module, a first subset of the first plurality of metadata based, at least in part, upon a data catalog policy to obtain a first classified metadata set,
determining that the first entity's data corresponding to the first classified metadata set must be migrated from a source location to a target location based, at least in part, upon the data catalog policy, and
migrating the first entity's data corresponding to the first classified metadata set from the source location to the target location.

8. The CPP of claim 7 wherein the first entity's data corresponding to the first classified metadata set is personal identifiable information (PII).

9. The CPP of claim 7 wherein the classification of the first subset of the first plurality of metadata is done automatically based upon the data catalog policy.

10. The CPP of claim 7 wherein the target location for migrating the first entity's data corresponding to the first classified metadata set is behind a firewall.

11. The CPP of claim 7 wherein the target location for migrating the first entity's data corresponding to the first classified metadata set is to a public cloud-based server.

12. The CPP of claim 7 wherein the data catalog policy is created by a data governance officer.

13. A computer system (CS) comprising:
a processor(s) set;
a machine readable storage device; and
computer code stored on the machine readable storage device, with the computer code including instructions and data for causing the processor(s) set to perform operations including the following:
receiving a data catalog, with the data catalog including a first plurality of metadata corresponding to a first entity's data,
classifying, using a machine learning module, a first subset of the first plurality of metadata based, at least in part, upon a data catalog policy to obtain a first classified metadata set,
determining that the first entity's data corresponding to the first classified metadata set must be migrated from a source location to a target location based, at least in part, upon the data catalog policy, and
migrating the first entity's data corresponding to the first classified metadata set from the source location to the target location.

14. The CS of claim 13 wherein the first entity's data corresponding to the first classified metadata set is personal identifiable information (PII).

15. The CS of claim 13 wherein the classification of the first subset of the first plurality of metadata is done automatically based upon the data catalog policy.

16. The CS of claim 13 wherein the target location for migrating the first entity's data corresponding to the first classified metadata set is behind a firewall.

17. The CS of claim 13 wherein the target location for migrating the first entity's data corresponding to the first classified metadata set is to a public cloud-based server.

18. The CS of claim 13 wherein the data catalog policy is created by a data governance officer.
